(19) United States
(12) Patent Application Publication
(10) Pub. No.: US 2006/0255504 A1
(43) Pub. Date: Nov. 16, 2006

(54) Method and casting mold for producing a protective layer on integrated components

(76) Inventors: Steffen Kroehnert, Dresden (DE); Ingolf Rau, Munich (DE); Knut Kahlisch, Dresden (DE); Theodorus Antonius Maria Hugen, Herwen (NL); Michel Hendrikus Lambertus Teunissen, Herwen (NL)

Correspondence Address: SLATER & MATSIL LLP, 17950 PRESTON ROAD, SUITE 1000, DALLAS, TX, 75252, US

(21) Appl. No.: 11/413,639

(22) Filed: Apr. 28, 2006

(30) Foreign Application Priority Data
Apr. 29, 2005 (DE) 10 2005 020 427.9

(51) Int. Cl. B29C 45/14

(52) U.S. Cl. 264/272.14; 425/416; 264/272.17

(57) ABSTRACT

In a method for producing an integrated component, a carrier strip is provided with at least one arrangement of chips. A casting mold is placed over the carrier strip in such a way that the arrangement of chips is covered completely by at least one cavity of the casting mold. A protective layer is formed over the arrangement of microchips by filling the cavity with a liquefied encapsulating compound. The liquefied encapsulating compound transforms into a solid state upon cooling. The carrier strip with the protective layer can be ejected from the cavity by exerting a force onto a surface of the protective layer facing the cavity. The force is exerted onto at least one linearly extended surface region of the protective layer.

This application claims priority to German Patent Application 10 2005 020 427.9, which was filed Apr. 29, 2005, and is incorporated herein by reference.

### TECHNICAL FIELD

The invention relates to a method and a casting mold for producing a protective layer on integrated components.

### BACKGROUND

For producing integrated components, usually a relatively large number of microchips are adhesively attached with their underside onto the upper side of a carrier strip. The carrier strip has contacting slots that serve the purpose of connecting the bonding islands arranged on the underside of the microchips by means of contact wires to corresponding bonding islands arranged on the underside of the carrier strip. The bonding islands are connected to soldering islands likewise arranged on the underside of the carrier strip.

The microchips are in this case arranged on the upper side of the carrier strip in rows and columns similar to a matrix, in such a way that the integrated components can later be separated by sawing up the carrier strip in the longitudinal and transverse directions. A number of such matrix-like arrangements of microchips, which in turn are arranged in relation to one another in a manner similar to a matrix, are often provided on a carrier strip.

Before the integrated components are separated by sawing up the carrier strip, a protective layer of an encapsulating compound is applied both to the underside and to the upper side of the carrier strip. For this purpose, different casting molds are used for the upper side and the underside, i.e., upper molds and lower molds. These casting molds usually have a number of cavities configured so that each cavity of the upper mold covers over a matrix-like arrangement of microchips and each cavity of the lower mold covers over all the contacting slots and the associated bonding islands, but the soldering islands remain free.

Known casting molds of the type described in the Background have one or more cavities on their underside and pin-shaped ejector elements with a punctiform contact area arranged displaceably in the bottom surface of the cavity. The ejector elements serve for ejecting a carrier strip once it has been provided with a protective layer.

For forming the protective layer, the casting mold is placed onto the upper side of a carrier strip, on which at least one matrix-like arrangement of microchips organized in rows and columns is provided, in such a way that the matrix-like arrangement is covered over completely by one of the cavities of the casting mold. Once the cavity is filled with a liquefied encapsulating compound and the liquefied encapsulating compound has partially cooled, the ejector elements are actuated, e.g., displaced perpendicularly in relation to the carrier strip, so that the ejector elements exert a force on the surface of the protective layer. On account of the pin shape of the ejector elements, the force effect is in this case punctiform. The force effect causes the carrier strip with the protective layer to be ejected from the casting mold.

The pin-shaped ejector elements are either arranged in edge regions of the cavity, and consequently outside the matrix-like arrangement of microchips, in order to obtain a casting mold that is as universally usable as possible, or they are arranged between individual microchips of the matrix-like arrangement, as a result of which however many different casting molds are required for microchips of different sizes.

If the pin-shaped ejector elements are arranged in the edge regions of the cavity, the force effect of the pin-shaped ejector elements has the effect that the carrier strip including the protective layer is bent. This may cause the microchips to be damaged, with the result that the integrated components produced in this way are unusable.

If, on the other hand, the pin-shaped ejector elements are arranged such that they are distributed over the bottom surface of the cavity, it must be ensured that the imprint left behind by the ejector element on the surface of the protective layer lies in the same place on each subsequent integrated component. As a result, it is necessary to provide a casting mold specifically for each size of microchips to be arranged on the carrier strip in a manner similar to a matrix. This entails high costs.

### SUMMARY OF THE INVENTION

In one aspect, the invention relates to a method for producing a protective layer on the underside of a carrier strip and to a casting mold used for it.

In a method for producing an integrated component, a carrier strip is provided with at least one arrangement of chips. A casting mold is placed over the carrier strip in such a way that the arrangement of chips is covered completely by at least one cavity of the casting mold. A protective layer is formed over the arrangement of microchips by filling the cavity with a liquefied encapsulating compound. The liquefied encapsulating compound transforms into a solid state upon cooling. The carrier strip with the protective layer can be ejected from the cavity by exerting a force onto a surface of the protective layer facing the cavity. The force is exerted onto at least one linearly extended surface region of the protective layer.

### DESCRIPTION OF THE DRAWINGS

The invention is explained in more detail below on the basis of an exemplary embodiment and associated drawings, in which:

FIG. 1 shows an exemplary embodiment of the casting mold according to the invention in the view from below; and

FIG. 2 shows a perspective detailed view of the exemplary embodiment.

The following list of reference symbols can be used in conjunction with the figures:

1 contact area
2 cavity
3 plate-shaped ejector element
4 crucible
5 feed channel
6 pin -shaped ejector element
21 side surface
22 bottom surface
23 slit-shaped recess
31 linearly extended contact area
61 punctiform contact area
62 circular recess

### DETAILED DESCRIPTION OF ILLUSTRATIVE EMBODIMENTS

In one aspect, the present invention provides a method for producing a protective layer on integrated components with which inadmissible deformations of the carrier strip are avoided. In a further aspect, the invention provides a casting mold for producing a protective layer on integrated components that can be used for a large number of different sizes of microchips.

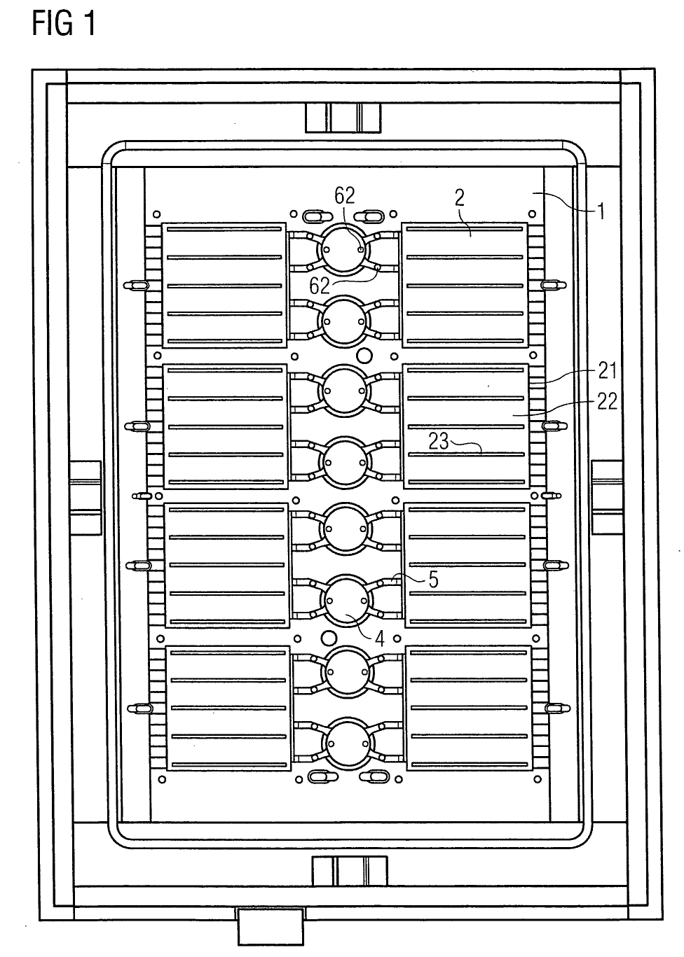

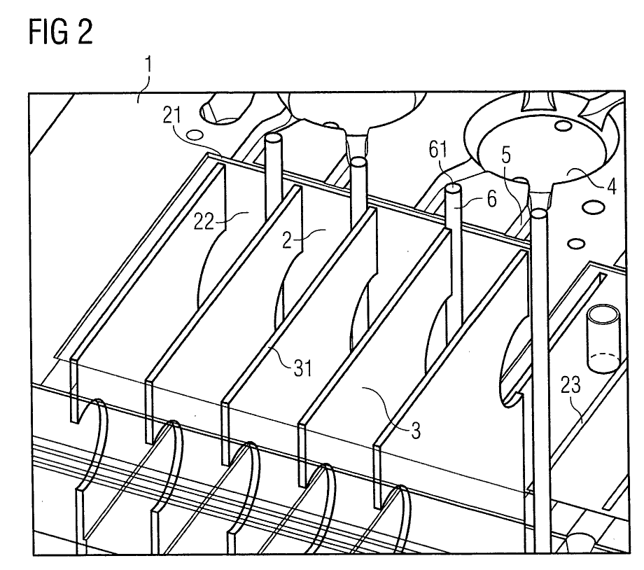

The present invention will now be described in the context of exemplary embodiments, which are described with respect to FIGS. 1 and 2.

The casting mold represented in the figures has a substantially planar contact area 1 with eight cavities 2. Each cavity 2 has a substantially planar bottom surface 22, delimited by side surfaces 21. In the bottom surface 22 of each cavity 2, five slit-shaped recesses 23 are provided, each for receiving a plate-shaped ejector element 3. The ejector elements 3 are displaceably mounted in the slit-shaped recesses 23 and have on the underside a linearly extended contact area 31 for the force transmission to the surface of the protective layer.

For filling the cavities 2 with liquefied encapsulating compound, eight crucibles 4 and four feed channels 5 for each crucible 4 are provided between the cavities 2.

Each crucible 4 is connected by two feed channels 5. These two feed channels 5 are each associated with two cavities 2 so that the encapsulating compound, which has been liquefied in a crucible 4, can be channeled to two different cavities 2. In the crucibles 4 and the feed channels 5, pin-shaped ejector elements 6 with a punctiform contact area 61 are displaceably arranged in a circular recess 62. As a result, the encapsulating compound that has solidified in the crucibles 4 and the feed channels 5 can also be ejected.

The recesses 23 and the plate-shaped ejector elements 3 guided in them are preferably, but not necessarily, arranged parallel to and equidistant from one another. Their distance apart is chosen such that a series, i.e., a row or column, of a matrix-like arrangement of microchips can be arranged between every two plate-shaped ejector elements 3.

In embodiments of the present invention, the bottom surface 22 and side surfaces 21 of each cavity 2 are designed for the complete coverage of a matrix-like arrangement of a number of microchips provided on a carrier strip. The surface of such a matrix-like arrangement, and consequently the required cavity, is kept to the same size irrespective of the size of the microchips, in order to manage with the fewest possible different casting molds and to make the subsequent separation of the integrated components by sawing up the matrix-like arrangement covered by the protective layer technologically simple.

As a result, with the width of the microchips remaining the same, the casting mold according to embodiments of the invention is suitable for matrix-like arrangements of microchips of different lengths. Since the force is exerted on surface regions lying between the rows or columns of a matrix-like arrangement of microchips organized in rows and columns, the surface regions of the protective layer lying over the microchips are not exposed to any direct force effect. This further ensures that the microchips lying under the not yet completely cured protective layer are not stressed by the force required for ejection. In this embodiment, the force effect accordingly only takes place in the edge regions of the subsequent integrated components.

The force required for ejection is exerted on a number of surface regions distributed over the surface of the protective layer. As a result, inadmissible deformations of the carrier strip are prevented or at least minimized. At the same time, the microchips located under the protective layer are not subjected to a force, since the surface regions of the protective layer located above them remain free from force.

According to a further embodiment of the method, imprints with a changed surface structure are created in the surface regions of the protective layer that are exposed to the force effect. These imprints may serve for example to facilitate the subsequent singulation of the integrated components. The force can be exerted on the surface of the protective layer in such a way that the imprints are created on the surface at such distances apart and with such dimensioning that they leave behind an imprint in the same position and form on each integrated component that can be singulated from the arrangement of microchips. This likewise facilitates the subsequent singulation of the integrated components.

In the prior art, the force was punctiform. In embodiments of the present invention, the linear force effect achieves a more uniform force transmission to the surface of the protective layer. As a result, inadmissible deformations of the carrier strip and resultant damage to the microchips are effectively prevented.

As discussed above, in one embodiment the force is exerted onto a number of surface regions of the protective layer lying parallel to one another. What is advantageous about this is that the force transmission is once again made more uniform, so that the stresses for the microchips during ejection from the casting mold are further reduced. The creation of a force on surface regions lying parallel also provides a uniform pressure distribution in the protective layer and is advantageous for technical production-related reasons.

As also noted above, the force can be exerted on equidistant surface regions of the protective layer. For the purposes of this invention, equidistant is intended to mean that the force acts on surface regions that are at the same distance from one another. In other words, for surface regions lying next to one another, the distance of each surface region from each neighboring surface region on which a force is exerted is the same.

The casting mold according to preferred embodiments of the invention makes it possible to carry out the method described above in an advantageous way, in that the force is transmitted from the ejector elements to linearly extended surface regions of the protective layer.

According to an embodiment of the casting mold, each ejector element has a substantially plate-shaped basic form 3. The plate form of the ejector elements ensures great mechanical stability and simple and low-cost producibility.

According to a further embodiment of the casting mold, each ejector element is mounted in a slit-shaped recess 23 of the casting mold that is provided for it. The slit-shaped recesses 23 receive the ejector elements with positive engagement and at the same time form a guide for the displacement of the ejector elements.

According to a further embodiment of the casting mold, each ejector element is resiliently mounted. The resilient mounting has the effect that the ejector elements are subjected to a restoring force, which ensures that the ejector elements automatically return to their position of rest after the ejection of the carrier strip.

What is claimed is:

1. A method for producing an integrated component, the method comprising:
providing a carrier strip with at least one arrangement of chips;
placing a casting mold over the carrier strip in such a way that the at least one arrangement of chips is covered completely by at least one cavity of the casting mold;
forming a protective layer over the at least one arrangement of chips by filling the at least one cavity with a liquefied encapsulating compound, wherein the liquefied encapsulating compound transforms into a solid state upon cooling; and
ejecting the carrier strip with the protective layer from the at least one cavity by exerting a force onto a surface of the protective layer facing the at least one cavity, wherein the force is exerted onto at least one linearly extended surface region of the protective layer.

2. The method as claimed in claim 1, wherein the force is exerted on a number of surface regions of the protective layer lying parallel to one another.

3. The method as claimed in claim 2, wherein the force is exerted on equidistant surface regions of the protective layer.

4. The method as claimed in claim 2, wherein the force is exerted on surface regions lying between rows or columns of a matrix-like arrangement of microchips organized in rows and columns, such that no surface region of the protective layer that overlies a chip is exposed to any direct force effect.

5. The method as claimed in claim 1, wherein the liquefied encapsulating compound transforms into a plastic state upon cooling.

6. The method as claimed in claim 5, wherein exerting a force onto a surface of the protective layer leaves imprints with a changed surface structure on the surface of the protective layer.

7. The method as claimed in claim 6, further comprising singulating the carrier strip at the imprints.

8. The method as claimed in claim 7, wherein the imprints lie parallel to one another and are spaced an equal distance from one another.

9. The method as claimed in claim 1, wherein the force is exerted on surface regions lying between rows or columns of a matrix-like arrangement of microchips organized in rows and columns, such that no surface region of the protective layer that overlies a chip is exposed to any direct force effect.

10. The method as claimed in claim 1, further comprising singulating the carrier strip to form a plurality of packaged chip components.

11. A casting mold for producing a protective layer on integrated components, the casting mold comprising:
a cavity arranged in a contact area, the cavity being delimited by side surfaces and having a bottom surface; and
at least one displaceably mounted ejector element located adjacent the bottom surface of the cavity, wherein the at least one displaceably mounted ejector element includes a linearly extended contact area.

12. The casting mold as claimed in claim 11, wherein the at least one displaceably mounted ejector element has a substantially plate-shaped basic form.

13. The casting mold as claimed in claim 11, wherein the at least one displaceably mounted ejector element is mounted in a slit-shaped recess of the casting mold provided for it.

14. The casting mold as claimed in claim 11, wherein the at least one displaceably mounted ejector element is resiliently mounted.

15. The casting mold as claimed in claim 1 1, wherein the at least one displaceably mounted ejector element comprises a plurality of ejector elements and wherein all ejector elements arranged in the cavity are arranged parallel to one another.

16. The casting mold as claimed claim 15, wherein all the ejector elements arranged in the cavity are arranged at an equal distance from one another.

17. A casting mold for producing a protective layer on an integrated component, the casting mold comprising:
a cavity arranged in a contact area, the cavity being delimited by side surfaces and a bottom surface and designed for the complete coverage of an arrangement of microchips provided on a carrier strip; and
at least one displaceably mounted ejector element for ejecting a carrier strip provided with a protective layer, wherein the at least one displaceably mounted ejector element has a linearly extended contact area for the force transmission to the surface of the protective layer.

18. The casting mold as claimed in claim 17, wherein the at least one displaceably mounted ejector element comprises a plurality of ejector elements.

19. The casting mold as claimed in claim 18, wherein the plurality of ejector elements arranged in a cavity are arranged at such distances apart and are formed with such dimensioning that they leave behind an imprint in the same position such that the imprint indicates a location wherein the carrier strip can be singulated to form a plurality of packaged microchips.

20. The casting mold as claimed in claim 18, wherein all ejector elements arranged in the cavity are arranged parallel to one another and at an equal distance from one another.
